(19) United States
(12) Patent Application Publication
(10) Pub. No.: US 2026/0364671 A1
(43) Pub. Date: Nov. 19, 2026

(54) CONTINUOUS FLOW COOLING DEVICE

(71) Applicant: EBNER Industrieofenbau GmbH, Leonding (AT)

(72) Inventors: Robert EBNER, Leonding (AT); Ulrich PSCHEBEZIN, Pucking (AT); Manoj KUMAR, Linz (AT)

(73) Assignee: EBNER Industrieofenbau GmbH, Leonding (AT)

(21) Appl. No.: 19/148,078

(22) PCT Filed: Jan. 16, 2024
(86) PCT No.: PCT/AT2024/060008

§ 371 Date: Jul. 15, 2025

(30) Foreign Application Priority Data
Jan. 16, 2023 (AT) A50018/2023

(51) Int. Cl. B22D 11/124

(52) U.S. Cl. CPC B22D 11/124

(57) ABSTRACT

A continuous cooling device for cooling a metal strip includes at least one strip cooler which has lower discharge elements for a gaseous fluid distributed along a flow direction of the metal strip and upper discharge elements for a gaseous fluid distributed along the flow direction of the metal strip; and liquid cooling units, with which the metal strip can be supplied with a cooling liquid, wherein at least one transport device with at least one transport element for transporting the metal strip is arranged between the upper and lower discharge elements.

The invention relates to a continuous cooling device for cooling a metal strip, having at least one strip cooler which has a plurality of lower discharge elements for a gaseous fluid distributed along a flow direction of the strip and a plurality of upper discharge elements for a gaseous fluid distributed along the flow direction of the strip, and having a plurality of liquid cooling units with which a cooling liquid can be applied to the metal strip.

The invention also relates to a system for the heat treatment of a metal strip with at least one strip casting device, in which the metal strip is produced from a melt, and optionally with at least one heat treatment device, in which the metal strip is heated or through which the metal strip passes in a heated state, and at least one continuous cooling device.

In addition, the invention relates to a method for cooling a metal strip in a continuous cooling device, with at least one strip cooler which has a plurality of lower discharge elements for a gaseous fluid distributed along a flow direction of the strip and a plurality of upper discharge elements for a gaseous fluid distributed along the flow direction of the strip, and which has a plurality of liquid cooling units with which a cooling liquid can be applied to the metal strip, wherein the metal strip is exposed for cooling to a gaseous fluid which is directed from the upper and lower discharge elements towards the metal strip, and to a cooling liquid which is applied to the metal strip flowing out from the liquid cooling units.

Continuous cooling devices of the design mentioned at the beginning are already known from the state of the art. For example, DE 10 2016 102 093 B3 describes a continuous cooling device for cooling a metal strip, having at least one floating strip cooler which has a plurality of upper nozzles distributed along the strip flow direction and a plurality of lower nozzles distributed along the strip flow direction, wherein the metal strip can be transported in a floating manner between the upper nozzles and the lower nozzles and both the upper side and the lower side of the strip can be subjected to cooling air, and with several water cooling units, with which cooling water can be applied to the metal strip, and which are integrated into the floating strip cooler in that at least one water cooling unit is arranged in several intermediate regions between two lower nozzles or upper nozzles arranged directly one behind the other in the strip flow direction.

WO 2018/162474 A1 describes a floating strip system for guiding a strip-shaped material in a floating state, which has a first nozzle system and a second nozzle system, wherein the first nozzle system is arranged relative to the second nozzle system in such a way that the strip-shaped material can be guided between the first nozzle system and the second nozzle system. The nozzle systems comprise a nozzle body which has a front edge area along a conveying direction of the belt-shaped material and a rear edge area opposite this, a front gas nozzle arrangement, which is arranged at the front edge area in such a way that a front gas jet can flow in the direction of the belt flow plane to form a floating nozzle field for the belt-shaped material, a rear gas nozzle arrangement, which is arranged at the rear edge area in such a way that a rear gas jet can flow in the direction of the belt flow plane to form the floating nozzle field for the belt-shaped material, a nozzle arrangement, which is arranged in front of the front gas nozzle arrangement and/or behind the rear gas nozzle arrangement in the conveying direction, wherein the nozzle arrangement is configured in such a way that a liquid fluid can flow in a fluid jet into the floating nozzle field in the direction of the belt flow plane for tempering the strip-shaped material.

The present invention is based on the object of improving the handling of a metal strip in a warm or hot state.

The object of the invention is solved with the continuous cooling system mentioned at the beginning, in which at least one transport device with at least one transport element for (temporarily) transporting the metal strip is arranged between the upper and lower discharge elements.

Further, the object of the invention is solved by the system mentioned at the beginning, which is provided with the continuous cooling device according to the invention.

In addition, the object is solved with the method mentioned at the beginning, according to which it is provided that a free initial section of the metal strip is placed on a transport element of a transport device, which is arranged between the upper and lower discharge elements, and is conveyed with the transport element through the continuous cooling device, that with or after leaving the free initial section, the conveying quantity of gaseous fluid is increased, so that the metal strip is brought into a floating state within the continuous cooling device.

The advantage here is that the transport device can be used to improve the strip infeed into the continuous cooling device. In particular, this makes it possible to achieve a stable state in the strip and the method more safely and quickly, as the floating of the metal strip is only activated when the free end section has already left the continuous cooling device. The contact related transport of the free initial section of the metal strip makes it possible to reduce the tensile stress applied to this section in the warm or hot state, thus reducing its influence on the metal strip.

According to an embodiment variant of the invention, it may be provided that the transport device has several transport modules which are arranged one behind the other in the flow direction of the belt. The modular design of the transport system makes it easier to adapt to different continuous cooling systems.

According to a further embodiment variant of the invention, it may be provided that the transport modules each have at least one transport element, whereby the adaptability of the transport system and thus generally also of the continuous cooling device to the progress of the treatment of the metal strip can be improved. In particular, this makes it easier to switch to the floating transport of the metal strip at an early stage in sections of the continuous cooling device. It is also possible to provide different transport elements or generally different transport modules in the continuous cooling device, adapted to the progress of the cooling of the metal strip or to the temperature of the metal strip during cooling.

According to a preferred embodiment variant of the invention, it may be provided that the transport element is formed by cables or belts or a mesh fabric or a perforated conveyor belt, which allows the gaseous fluid and/or the cooling fluid to flow through the transport element so that the transport element can remain in the area between the upper and lower discharge elements for the gaseous fluid. This also ensures that the transport device is ready for use again more quickly if required.

According to a further embodiment variant of the invention, it may be provided that the transport element is arranged to rotate on reels or rollers in order to be able to influence the temperature load on the transport element via the heat dissipation by means of the reels or rollers. If necessary, the reels or rollers can be cooled.

According to an embodiment variant of the invention, it may be provided that the reels or rollers have a coating by means of which the force transmission from the reels or rollers to the transport element or transport elements can be better defined.

According to another embodiment variant, to simplify the transition from the contacted to the contactless transport state of the metal strip, it may be provided that at least the transport element of the transport device is height adjustable. The transport element can be lowered during the formation of the floating state of the metal belt using the height adjustment. It is therefore also possible to influence the intended shape of the floating of the metal strip, such as a flat, sinusoidal or corrugated floating of the metal strip, at an earlier stage during the changeover.

According to a further embodiment variant of the invention, it may be provided that the transport modules are individually height adjustable, which means that the lowering can be carried out only in sections or in stages, etc., if required.

For the same purpose, according to another embodiment variant of the invention, it may be provided that the transport elements of the transport modules are individually height adjustable.

According to an embodiment variant of the invention, the liquid cooling units may be arranged between discharge elements for a gaseous fluid, whereby cooling liquid can be blown off the metal strip with the gaseous fluid. This allows an improved cooling line to be generated across the width of the belt and enables targeted removal of liquid from the strip surface.

Due to the improved adaptability to different continuous cooling devices, it is advantageous if liquid cooling units are arranged within the transport modules according to a further embodiment variant of the invention.

According to an embodiment variant of the system, the continuous cooling device may be arranged directly adjacent to the strip casting device. A relatively large cooling gradient window can be made available with gas cooling or gas-liquid cooling, which means that a wide variety of metals can be processed with the system. In addition, the continuous cooling device can be used to enable contactless transport of the metal strip after the strip entry phase, allowing the surface of the metal strip to be free of damage.

For a better understanding of the invention, it is explained in more detail with the aid of the following figures.

These show respectively in a simplified schematic representation:

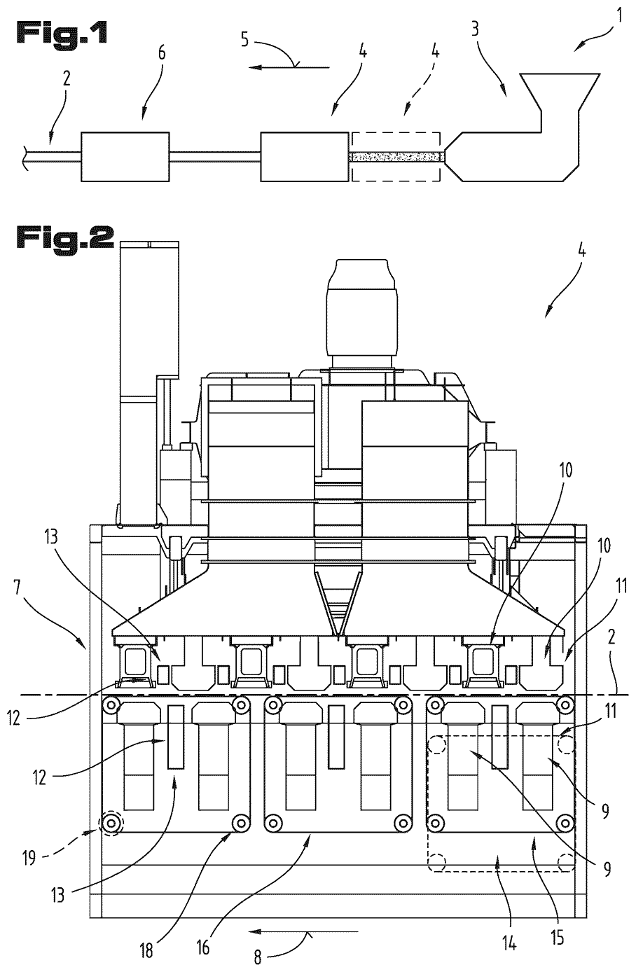

FIG. 1 a section of a system for producing a metal strip;

FIG. 2 a continuous cooling device;

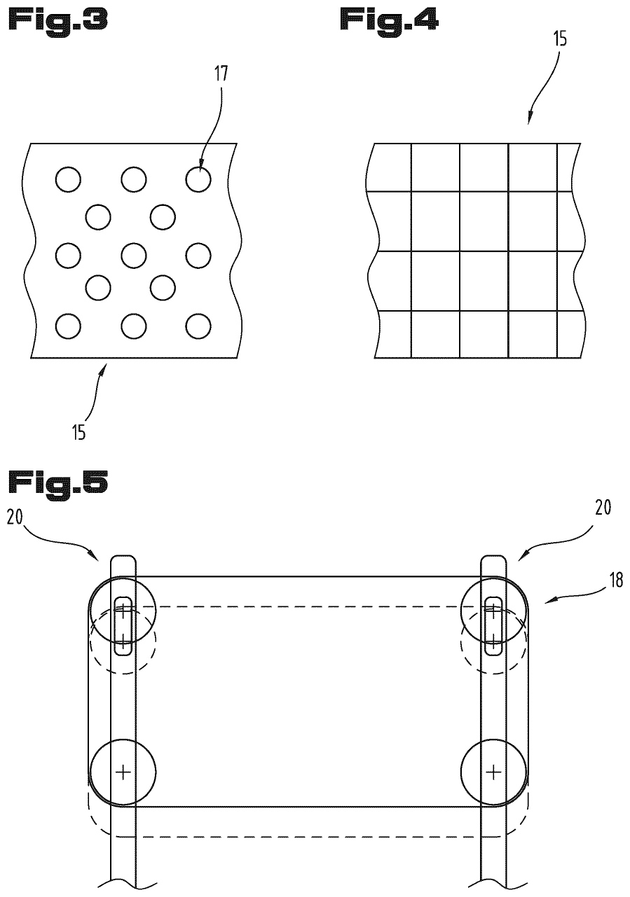

FIG. 3 a top view of a section of an embodiment variant of a transport element;

FIG. 4 a top view of a section of a further embodiment variant of a transport element;

FIG. 5 an embodiment variant of a transport device.

By way of introduction, it should be noted that in the various embodiments described, the same parts are provided with the same reference signs or the same component designations, wherein the disclosures included in the entire description may be transferred analogously to the same parts with the same reference signs or the same component designations. The position details chosen in the description, such as top, bottom, side, etc., also refer to the directly described and illustrated figure and these position details are to be transferred to the new position accordingly in the event of a change of position.

FIG. 1 shows schematically a section of a system 1 for producing a metal strip 2. The metal strip 2 consists in particular of a non-ferrous metal or a non-ferrous metal alloy, such as aluminium or a non-ferrous metal. However, the metal strip 2 may also be made of an iron-based material, such as steel.

The system 1 (also referred to as a “continuous casting line”) comprises a strip casting device 3 and a continuous cooling device 4 (also referred to as a floating strip cooler). The continuous cooling device 4 is preferably provided for the horizontal passage of the metal strip 2.

The metal strip is produced from a melt in the strip casting device 3. The strip casting device 3 may be configured in accordance with the state of the art, so that reference is made to the relevant state of the art for further details. For example, the strip casting device 3 can be a so-called strip caster, a twin roll caster, etc. The strip casting device 3 is in particular a continuously operated casting device.

The continuous cooling device 4 is arranged downstream of the strip casting device 3 in a production direction 5. The continuous cooling device 4 is described in more detail below.

The system 1 may also have further units or components, such as a heat treatment device 6 in which the metal strip 2 is heated or which the metal strip 2 passes through while heated. As these other units of the system 1 may also correspond to the state of the art, they will not be discussed further in order to avoid repetition. The heat treatment device 6 may be arranged behind or in front of the continuous cooling device 4 in the production direction 5 of the metal strip 2. In the preferred embodiment variant, however, the continuous cooling device 4 may be arranged downstream of the strip casting device 3 in the production direction 5 of the metal strip 2, in particular directly downstream, as is illustrated by the stroke-dotted line in FIG. 1. The continuous cooling device 4 may therefore be arranged at the exit of the metal strip 1 from the strip casting device 3, so that the already at least partially solidified metal strip 2 can enter the continuous cooling device 5 directly.

The continuous cooling device 4 for cooling a metal strip 2 can be seen more clearly in FIG. 2, which shows a schematic side view of the continuous cooling device 4.

The continuous cooling device 4 has at least one strip cooler 7. However, the continuous cooling device 4 may also have several strip coolers 7, for example two or three or four strip coolers 7 arranged one behind the other and/or side by side. If the continuous cooling device 4 has several strip coolers 7, these have preferably the same configuration. Therefore, only one strip cooler 7 is discussed in more detail below. If required, the explanations can be transferred to other strip coolers 7 of the continuous cooling device 4.

The strip cooler 7 has a plurality of lower discharge elements 9 for a gaseous fluid, arranged one behind the other along a flow direction 8 of the metal strip 2 through the continuous cooling device 4, and a plurality of upper discharge elements 10 for a gaseous fluid, arranged one behind the other along the flow direction 8 of the metal strip 2. The lower discharge elements 9 are arranged at a distance from each other. The discharge elements 10 are also arranged at a distance from each other. Furthermore, the lower discharge elements 9 are arranged at an angle to the upper discharge elements 10, so that the metal strip 2 can be conveyed between the lower and upper discharge elements 9, 10 through the continuous cooling device 4.

Air in particular is used as the gaseous fluid; but another gas may also be used.

The lower and upper discharge elements 9, 10 for the gaseous fluid may be configured according to the state of the art. For example, they may have a housing 11 that forms or contains a supply channel for the gaseous fluid. One or more nozzles for discharging the gaseous fluid may be arranged or formed on the housing 11. A high heat transfer (high heat transfer coefficient) can thus be achieved. In particular, the nozzle(s) is/are arranged or aligned in such a way that the gas stream flowing out is directed onto the metal strip 2. The nozzle(s) may have slit-like outlets so that the nozzle(s) is/are beam-shaped. The housing 11 or the nozzle(s) preferably extend(s) across the entire width of the metal strip 2. If a plurality of nozzles is provided, they may be arranged in such a way that the metal strip 2 can be supplied with a gas flow across its entire width.

To supply the lower and upper discharge elements 9, 10 with the gaseous fluid, a blower or fan may be provided, which is flow-connected to the lower and upper discharge elements 9, 10. A plurality of blowers or a fan may also be provided. The lower and upper discharge elements 9, 10 may be supplied with the gaseous fluid independently of each other or together.

The strip cooler 7 also has several liquid cooling units 12. The liquid cooling units 12 can be used to apply a cooling liquid to the metal strip 2. An improved, i.e. more homogeneous, cooling can be achieved with these liquid cooling units 12. In particular, a more homogeneous cooling line (linear cooling area) can be achieved transverse to the direction of flow 8.

Water in particular may be used as a cooling liquid. However, other liquids may also be used as cooling liquids.

The liquid cooling units 12 may be configured according to the state of the art. For example, they may have a housing 13 that forms or contains a supply channel for the cooling liquid. One or a plurality of nozzles for discharging the cooling liquid may be arranged or configured on the housing 13, for example as flat jet nozzles, full cone nozzles, atomiser nozzles or hollow cone nozzles. The nozzle(s) is/are arranged or aligned in particular in such a way that the liquid flow flowing out is directed onto the metal strip 2. The nozzle(s) may have slit-like outlets so that the nozzle(s) is/are beam-shaped. The housing 11 or the nozzle(s) preferably extend(s) across the entire width of the metal strip 2. If a plurality of nozzles is provided, they may be arranged in such a way that the metal strip 2 can be supplied with a gas flow across its entire width. For example, the nozzles may be arranged or configured in one or more rows on the housing 13, which extend in the direction of the width of the metal strip 2.

To supply the nozzle(s) with the cooling liquid, one or a plurality of pumps may be provided which are connected to the nozzle(s) by a flow connection. The nozzles may be supplied independently or together with the cooling liquid.

Liquid cooling units 12 may be arranged between the lower discharge elements 9 and between the upper discharge elements 10. They may be arranged only between the lower discharge elements 9 or only between the upper discharge elements 10. One or a plurality of lower or upper discharge elements 9, 10 may be arranged between the liquid cooling units 12. The representation chosen in FIG. 2 is therefore not to be understood as limiting the scope of protection of the invention.

The lower and upper discharge elements 9, 10 and the liquid cooling units 14 are arranged in the continuous cooling device 4 in such a way that they do not touch the metal strip 2 during operation of the continuous cooling device 4.

Appropriate control valves may be provided to control the lower and upper discharge elements 9, 10 and/or the liquid cooling units 12.

Between the upper and lower discharge elements 9, 8, the continuous cooling device 4 has at least one transport device 14 with at least one transport element 15 for temporarily transporting the metal strip 2.

In the embodiment variant of the continuous cooling device 4 shown in FIG. 2, the transport device 14 has a modular design and has three transport modules 16. The transport device 14 may also have fewer or more than three transport modules 16, for example two or four or five, etc., so that the transport device 14 can be adapted to different lengths of the continuous cooling device 4. However, the transport device 14 may also extend continuously through the continuous cooling device 4 or a section of the continuous cooling device 4 and have only a single transport element 15, which extends continuously over the entire length of the continuous cooling device 4 or the said section of the continuous cooling device 4.

The transport modules 16 of the transport device 15 are arranged one behind the other in the flow direction 8 of the metal strip 2. However, it is also conceivable that, alternatively or additionally, a plurality of transport modules 16 is arranged side by side in the continuous cooling device 4, i.e. transversely (in particular at right angles) to the flow direction 8 of the metal strip 2.

One or a plurality of lower discharge elements 9 for a gaseous fluid and one or a plurality of liquid cooling units 12 may be assigned to the transport modules 16. For example, each of the transport modules 16 of the embodiment variant of the continuous cooling device 4 shown in FIG. 2 has two lower discharge elements 9 and a liquid cooling unit 12. However, this number should not be understood as limiting the scope of protection of the invention. More than two lower discharge elements 9 for a gaseous fluid, for example three or four, etc., and/or more than one liquid cooling unit 12, for example two or three, etc., per transport module 16 may also be provided. Preferably, the number of liquid cooling units 12 per transport module 16 is smaller than the number of lower discharge elements 9 for a gaseous fluid.

In the embodiment variant of the transport device 14 with the transport modules 16, each of the transport modules 16 or at least a plurality of the transport modules 16 preferably has its own transport element 15. However, it is also conceivable that a plurality of transport modules 16 shares a common transport element 15.

The at least one transport element at least temporarily supports and transports the metal strip 2 through the continuous cooling device 4, in particular at the beginning, i.e. during the strip entry phase. This refers to the phase of the strip flow which a new strip is introduced into the continuous cooling device 4, so that the free initial section of the metal strip 2 is located between the lower and upper discharge elements 9, 10 for the gaseous fluid. When this initial section has left the continuous cooling device 4 again and, in particular, a stable process state has been reached, i.e. when the strip is already wound into a coil under tension, the strip is conveyed through the continuous cooling device 4 while floating on the gaseous fluid. In order to simplify the transition between the support of the metal strip 2 and the floating of the metal strip 2, the transport element may be formed by cables or belts or a mesh fabric or a perforated conveyor belt according to an embodiment variant of the continuous cooling device 4. Reference is made to FIGS. 3 and 4, which show sections of a transport element 15 in the form of a “perforated belt” with apertures 17 in FIG. 3 and in the form of a mesh fabric in FIG. 4.

However, it should be noted that the transport element may be formed by an continuous belt (i.e. a belt without apertures 17) which extends over at least 50%, for example at least 80%, of the total width of the metal strip 2 transverse to the flow direction 8.

The number, size and shape of the apertures 17 may vary. For example, a portion of between 40% and 80% of the surface of the transport element 15 may be formed as apertures 17. The apertures 17 may be round, square or generally polygonal. It is also conceivable for the transport element 15 to have several different apertures 17.

In the event that cables and/or several belts arranged side by side are used, these individual elements are arranged at a distance from one another so that the apertures 17 are formed due to the distance between the cables and/or belts. The distance between the cables and/or belts and their number may be selected depending on the design of the continuous cooling device 4 or the metal strip 2. For example, between two and twenty cables and/or belts may be arranged in the continuous cooling device 4 as transport elements 15 for the metal strip 2.

In general, the transport element 15 or the transport elements 15 may be made of a metal or metal-composite material, such as metal-mineral fibre composites, in particular with glass fibres, or metal composites with ceramic particles, etc.

According to the preferred embodiment variant of the continuous cooling device 4, rollers 18 or reels or generally rotatable or rotatably mounted support elements are provided for guiding the transport element 15 or the transport elements 15. In the modular design variant, rollers 18 or reels are provided at the corners at which the respective transport element 15 is deflected, as may be seen in FIG. 2. However, more than these rollers 18 or reels may generally also be provided in the deflection areas within the scope of the invention, in particular if the transport element 15 covers longer distances between these deflection areas, in which case further support of the transport element 15 is advantageous.

At least one of the rollers 18 or reels (per transport module 16) may be driven if necessary.

The support (and guidance) of the at least one transport element 15 may also be provided by other, possibly driven, support elements.

It is also conceivable that the support elements, for example the rollers 18 or reels, have a surface profiling in order to transmit a driving force to the transport element(s) 15. The surface profiling may for example be a toothing. The transport element(s) 15 may also have a surface profiling on the side facing the support elements, for example a toothing, which interacts with the surface profiling of the support elements.

The transport element 15 or the transport elements 15 may be provided with a separate cooling, for example from below (the side on which the metal strip 2 does not rest) with a liquid or gaseous cooling medium. In the implementation with the rollers 18, these may be cooled and thus transfer the cooling effect to the transport element(s) 15.

According to a further embodiment variant, it may be provided that the reels or rollers 18 have a coating 19, as is indicated by a stroke-dotted line on the lower left roller 18 in FIG. 2.

The coating 19 may be a friction-reducing coating 19 in order to reduce the friction between the rollers 18 and the transport element 15. For example, the coating may consist in Al₂O₃, for which purpose the rollers 18 may be anodised, for example.

However, the coating 19 may also be a friction-enhancing coating 19 in order to increase the friction between the rollers 18 and the transport element 15 and to improve the force transmission between the roller 18 and the transport element 15 or the reel and the transport element 15.

Rollers 18 or reels with different coatings 19 may also be provided in a continuous cooling device 4. For example, both rollers 18 or reels with a friction-reducing coating 19 and rollers 18 or reels with a friction-increasing coating 19 may be arranged.

As already explained, the transport of the metal strip 2 through the continuous cooling device 4 is preferably switched to a suspension of the metal strip 2 in the course of the method. In addition to the apertures 17 described above or as an alternative thereto, according to an embodiment variant it may be provided that at least the transport element 15 of the transport device 14 or the transport modules 16 is height adjustable. For example, at least the upper support elements, for example rollers 18, may be arranged or held in a lowerable manner in a holder 20, for example a holding frame, as indicated in FIG. 5. In this case, the (respective) transport element 15 can lose its contact with the lower support elements when it is lowered. It is also conceivable that all transport modules 16 or the entire transport device 14 can be lowered, as indicated by the stroke-dotted line on the right-hand transport module 16 in FIG. 2. For this purpose, for example, a link motion may be provided in which the corresponding elements of the transport device 14 are held/guided so that they can be lowered.

A corresponding drive or drives, such as at least one electric motor, a hydraulic or pneumatic actuator, etc., may be provided for lowering the respective elements of the transport device 14.

According to a further embodiment variant, it is conceivable for the transport modules 16 to be individually height adjustable, so that the changeover from contact conveying of the metal strip 2 to floating conveying can be carried out in stages or in sections. In general, this enables demand-orientated contact conveying of the metal strip 2 with at least one transport element 15. For this purpose, corresponding sensors and/or a control or regulating device may be provided in/on the continuous cooling device 4. The sensors may be used, for example, to determine the position of the metal strip 2 within the continuous cooling device 4.

A method for cooling a metal strip 2 in a continuous cooling device 4 may be carried out with the system 1, wherein the continuous cooling device 4 has at least one strip cooler 7 which has a plurality of lower discharge elements 9 for a gaseous fluid distributed along a flow direction 8 of the metal strip 2 and a plurality of upper discharge elements 10 for a gaseous fluid distributed along the flow direction 8 of the metal strip 2, and which has a plurality of liquid cooling units 12 with which a cooling liquid can be applied to the metal strip 2, wherein the metal strip 2 is exposed during cooling to a gaseous fluid which is directed from the upper and lower discharge elements 9, 10 in the direction of the metal strip and to a cooling liquid which is applied to the metal strip 2 flowing out from the liquid cooling units 12. A free initial section of the metal strip 2 is placed on at least one transport element 15 of the transport device 14, which is arranged between the upper and lower discharge elements 9, 10, and conveyed with the transport element 15 through the continuous cooling device 4. With or after leaving the free end section of the metal strip, the conveying quantity of gaseous fluid or the volume flow of gaseous fluid is increased, so that the metal strip 2 is brought into a floating state within the continuous cooling device. At least the transport element 15 of the transport device 14 may also be lowered. The increase in the volume flow of gaseous fluid may be achieved by increasing the speeds of the aforementioned fans (which may be configured as circulation fans, for example) or blowers.

If necessary, when a free end section of the metal strip 2 is reached, the floating conveying can be switched back to the contact-guided conveying state by reversing these processes.

The exemplary embodiments show or describe possible embodiment variants of the system 1 or the continuous cooling device 4, wherein combinations of the individual embodiment variants are also possible.

Finally, for the sake of order, it should be noted that for a better understanding of the structure of the system 1 or the continuous cooling device 4, these are not necessarily shown to scale.

### LIST OF REFERENCE SIGNS

1 system
2 metal strip
3 strip casting device
4 continuous cooling device
5 production direction
6 heat treatment device
7 strip cooler
8 flow direction
9 discharge element
10 discharge element
11 housing
12 liquid cooling unit
13 housing
14 transport device
15 transport element
16 transport module
17 aperture
18 roller
19 coating
20 bracket

1. A continuous cooling device (4) for cooling a metal strip (2), having at least one strip cooler (7) which has a plurality of lower discharge elements (9) for a gaseous fluid distributed along a flow direction (8) of the metal strip (2) and a plurality of upper discharge elements (10) for a gaseous fluid distributed along the flow direction (8) of the metal strip (2), and having a plurality of liquid cooling units (12), with which the metal strip (2) can be supplied with a cooling liquid, wherein at least one transport device (14) with at least one transport element (15) for transporting the metal strip (2) is arranged between the upper and lower discharge elements (9, 10).

2. The continuous cooling device (4) according to claim 1, wherein the transport device (14) has a plurality of transport modules (15) which are arranged one behind the other in the flow direction (8) of the metal strip (2).

3. The continuous cooling device (4) according to claim 2, wherein the transport modules (16) have each at least one transport element (15).

4. The continuous cooling device (4) according to claim 1, wherein the transport element (15) is formed by cables or belts or a mesh fabric or a perforated conveyor belt.

5. The continuous cooling device (4) according to claim 1, wherein the transport element (15) is arranged circumferentially on reels or rollers (18).

6. The continuous cooling device (4) according to claim 5, wherein the reels or rollers (18) have a coating (19).

7. The continuous cooling device (4) according to claim 1, wherein at least the transport element (15) of the transport device (14) is height adjustable.

8. The continuous cooling device (4) according to claim 2, wherein the transport modules (15) are individually height adjustable.

9. The continuous cooling device (4) according to claim 3, wherein the transport elements (15) of the transport modules (16) are individually height adjustable.

10. The continuous cooling device (4) according to claim 1, wherein liquid cooling units (12) are arranged between lower and/or upper discharge elements (9, 10) for a gaseous fluid.

11. The continuous cooling device (4) according to claim 2, wherein the liquid cooling units (12) are arranged within the transport modules (16).

12. : A system (1) for producing a metal strip (2) with at least one strip casting device (3), in which the metal strip (1) is produced from a melt, and optionally at least one heat treatment device (6), in which the metal strip (2) is heated or through which the metal strip (2) passes in a heated state, and at least one continuous cooling device (4), wherein the continuous cooling device (4) is configured according to claim 1.

13. The system according to claim 12, wherein the continuous cooling device (4) is arranged directly adjacent to the strip casting device (3).

14. A method for cooling a metal strip (2) in a continuous cooling device (4), with at least one strip cooler (7) which has a plurality of lower discharge elements (9, 10) for a gaseous fluid distributed along a flow direction (8) of the strip and a plurality of upper discharge elements (9, 10) for a gaseous fluid distributed along a flow direction (8) of the strip, and which has a plurality of liquid cooling units (12) with which the metal strip (2) can be supplied with a cooling liquid, wherein the metal strip (2) is exposed for cooling to a gaseous fluid which is directed from the upper and lower discharge elements in the direction of the metal strip, and a cooling liquid which is applied to the metal strip flowing out from the liquid cooling units, wherein a free initial section of the metal strip is placed on a transport element of a transport device which is arranged between the upper and lower discharge elements and is conveyed with the transport element through the continuous cooling device, wherein the delivery quantity of gaseous fluid is increased with or after leaving the free end section, so that the metal strip is brought into a floating state within the continuous cooling device.
